(19) United States
(12) Patent Application Publication
(10) Pub. No.: US 2016/0162814 A1
(43) Pub. Date: Jun. 9, 2016

(54) COMPARATIVE PEER ANALYSIS FOR BUSINESS INTELLIGENCE

(71) Applicant: International Business Machines Corporation, Armonk, NY (US)

(72) Inventors: Ilse M. Breedvelt-Schouten, Manotick (CA); Mohsen Rais-Ghasem, Ottawa (CA)

(21) Appl. No.: 14/827,049

(22) Filed: Aug. 14, 2015

Related U.S. Application Data
(63) Continuation of application No. 14/561,017, filed on Dec. 4, 2014.

(51) Int. Cl. G06Q 10/06

(52) U.S. Cl. CPC G06Q 10/063

(57) ABSTRACT

Techniques are described for comparative peer analysis for business intelligence (BI). In one example, a method includes identifying, in response to an input indicating one or more features of a BI report context associated with an enterprise, one or more elements of information associated with one or more peer entities of the enterprise from one or more information sources, wherein the one or more elements of information associated with one or more peer entities correspond with the one or more indicated features of the BI report context. The method further includes generating an output comprising the one or more elements of information associated with the one or more peer entities that correspond with the one or more indicated features of the BI report context.

This application is a continuation of U.S. application Ser. No. 14/561,017, filed on Dec. 4, 2014 entitled COMPARATIVE PEER ANALYSIS FOR BUSINESS INTELLIGENCE, the entire content of which is incorporated herein by reference.

### TECHNICAL FIELD

The disclosure relates to business intelligence (BI) systems, and more particularly, to financial reporting for BI systems.

### BACKGROUND

Enterprise software systems are typically sophisticated, large-scale systems that support many, e.g., hundreds or thousands, of concurrent users. Examples of enterprise software systems include financial planning systems, budget planning systems, order management systems, inventory management systems, sales force management systems, business intelligence tools, enterprise reporting tools, project and resource management systems, and other enterprise software systems.

Many enterprise performance management and business planning applications require a large base of users to enter data that the software then accumulates into higher level areas of responsibility in the organization. Moreover, once data has been entered, it must be retrieved to be utilized. The system may perform mathematical calculations on the data, combining data submitted by many users. Using the results of these calculations, the system may generate reports for review by higher management. Often, these complex systems make use of multidimensional data sources that organize and manipulate the tremendous volume of data using data structures referred to as data cubes. Each data cube, for example, includes a plurality of hierarchical dimensions having levels and members for storing the multidimensional data.

Business intelligence (BI) systems may be used to provide financial reporting based on collections of enterprise data. Some analytical goals of financial reporting may prompt users to gather additional information to enter into spreadsheets or other data files to be added to the inputs for BI analysis and financial reporting.

### SUMMARY

In general, examples disclosed herein are directed to techniques for automated comparative peer analysis for BI financial reporting. In various examples, a BI system with comparative peer analysis of this disclosure may apply rules to identify peers of a BI user enterprise and to automatically gather information related to the enterprise's peers from authoritative sources. A BI system with comparative peer analysis of this disclosure may process and store the peer information, and may further provide direct comparison of the enterprise's information with one or more peers' information for BI financial reporting.

In one example, a method of comparative peer analysis for BI includes identifying, by one or more processors, in response to an input indicating one or more features of a BI report context associated with an enterprise, one or more elements of information associated with one or more peer entities of the enterprise from one or more information sources, wherein the one or more elements of information associated with one or more peer entities correspond with the one or more indicated features of the BI report context. The method further includes generating, by the one or more processors, an output comprising the one or more elements of information associated with the one or more peer entities that correspond with the one or more indicated features of the BI report context.

In another example, a computer program product for comparative peer analysis for BI includes a computer-readable storage medium having program code embodied therewith. The program code is executable by at least one processing device to identify, in response to an input indicating one or more features of a BI report context associated with an enterprise, one or more elements of information associated with one or more peer entities of the enterprise from one or more information sources, wherein the one or more elements of information associated with one or more peer entities correspond with the one or more indicated features of the BI report context. The program code is further executable by the at least one processing device to generate an output comprising the one or more elements of information associated with the one or more peer entities that correspond with the one or more indicated features of the BI report context.

In another example, a computer system for comparative peer analysis for BI includes one or more processors, one or more computer-readable memories, and one or more computer-readable, tangible storage devices. The computer system further includes program instructions, stored on at least one of the one or more storage devices for execution by at least one of the one or more processors via at least one of the one or more memories, to identify, in response to an input indicating one or more features of a BI report context associated with an enterprise, one or more elements of information associated with one or more peer entities of the enterprise from one or more information sources, wherein the one or more elements of information associated with one or more peer entities correspond with the one or more indicated features of the BI report context. The computer system further includes program instructions, stored on at least one of the one or more storage devices for execution by at least one of the one or more processors via at least one of the one or more memories, to generate an output comprising the one or more elements of information associated with the one or more peer entities that correspond with the one or more indicated features of the BI report context.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example enterprise having a computing environment in which users interact with an enterprise business intelligence system that includes a comparative peer analysis tool.

FIG. 2 is a block diagram illustrating one embodiment of an enterprise business intelligence computing environment, including a comparative peer analysis tool as part of a BI computing system.

FIG. 3 shows a conceptual diagram of an example client computing device rendering a BI financial reporting application user interface for a BI financial reporting application within a BI portal and enabled to access a comparative peer analysis tool.

FIG. 4 shows a conceptual block diagram of an example computing environment in which a comparative peer analysis tool responds to an input from a financial reporting application requesting comparative peer analysis of indicated features of a BI report context associated with an enterprise.

FIG. 5 depicts an example conceptual block diagram of a comparative peer analysis tool interacting with data stores and identifying and processing comparative peer information for a comparative peer analysis.

FIG. 6 shows a conceptual diagram of an example client computing device rendering a BI financial reporting application user interface after a BI financial reporting application has received an output generated by a comparative peer analysis tool.

FIG. 7 shows a conceptual diagram of an example client computing device rendering a BI financial reporting application user interface, also after a BI financial reporting application has received an output generated by a comparative peer analysis tool.

FIG. 8 shows a flowchart for an example process that a comparative peer analysis tool executing on one or more computing devices in an enterprise BI system may perform.

FIG. 9 is a block diagram of an example computing device that may execute a comparative peer analysis tool as part of an enterprise BI system.

### DETAILED DESCRIPTION

Various examples are disclosed herein directed to techniques, methods, systems, and devices for automated authoritative peer comparison for BI financial reporting. A BI system with authoritative peer comparison of this disclosure may apply rules to identify peers of a BI user enterprise, to identify authoritative sources of information on those peers, and to automatically gather information related to the enterprise's peers from the authoritative sources. The peer information may include financial or other numerical data, text, or other forms of information. A BI system with authoritative peer comparison of this disclosure may process or format the information related to the enterprise's peers to store the information in spreadsheets or other data sources in a BI system.

For example, the authoritative peer information sources may include structured or unstructured data sources, and the BI system with authoritative peer comparison may perform text mining, structured querying, indexing, or other techniques to process, format, or consolidate the authoritative peer information to store in spreadsheets, databases, or other data sources accessible to or as part of the BI system. A BI system with authoritative peer comparison of this disclosure may then provide direct comparison of the enterprise's information with one or more peers' information for BI financial reporting. For example, when a user is performing financial reporting with the BI system, the BI system may enable options to perform automatic comparison with peer information in a financial reporting tool. For example, when a user is preparing or analyzing a financial report with the BI system, the BI system may enable options to select peer information comparable to the enterprise's information in the financial report, and present a comparison of the peer information and the enterprise's information. The BI system may use metadata from the financial report as a basis for selecting and presenting the peer information directly comparable to the information of interest in the financial report. A general context of a BI system, along with details of how such a system may incorporate authoritative peer comparison, are described below with reference to the corresponding figures.

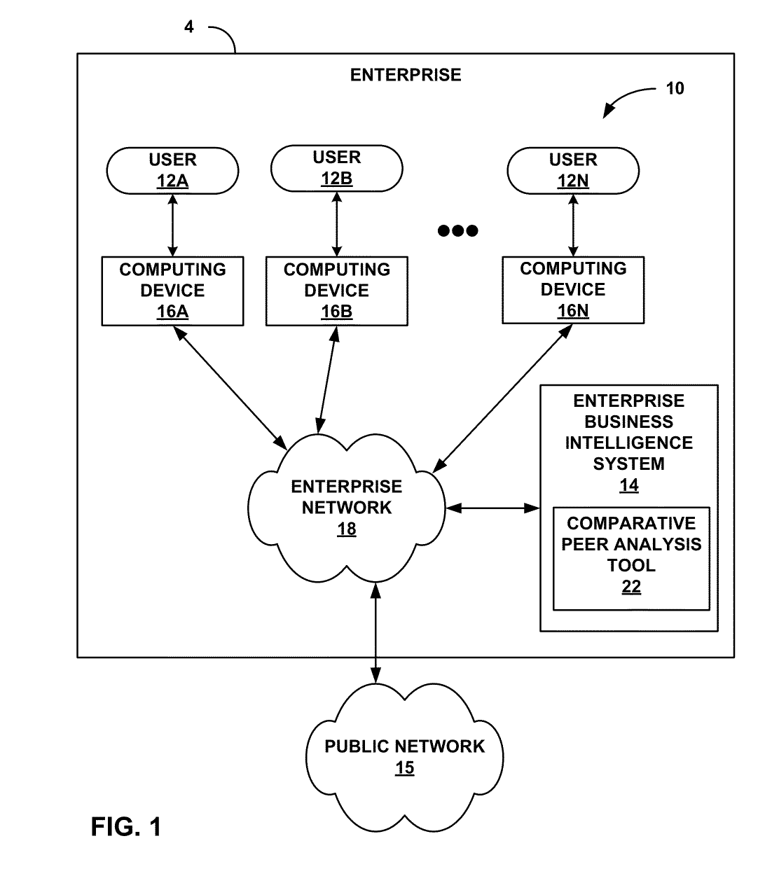

FIG. 1 illustrates an example context in which a system of this disclosure may be used. FIG. 1 is a block diagram illustrating an example enterprise 4 having a computing environment 10 in which a plurality of users 12A-12N (collectively, “users 12”) may interact with an enterprise business intelligence (BI) system 14 that includes a comparative peer analysis tool 22, as described further below. In the system shown in FIG. 1, enterprise business intelligence system 14 is communicatively coupled to a number of client computing devices 16A-16N (collectively, “client computing devices 16” or “computing devices 16”) by an enterprise network 18. Users 12 interact with their respective computing devices to access enterprise business intelligence system 14. Users 12, computing devices 16A-16N, enterprise network 18, and enterprise business intelligence system 14 may all be either in a single facility or widely dispersed in two or more separate locations anywhere in the world, in different examples.

For exemplary purposes, various examples of the techniques of this disclosure may be readily applied to various software systems, including enterprise business intelligence systems or other large-scale enterprise software systems. Examples of enterprise software systems include enterprise financial or budget planning systems, order management systems, inventory management systems, sales force management systems, business intelligence tools, enterprise reporting tools, project and resource management systems, and other enterprise software systems.

In this example, enterprise BI system 14 includes servers that run BI dashboard web applications and may provide business analytics software. A user 12 may use a BI portal on a client computing device 16 to view and manipulate information such as business intelligence reports (“BI reports”) and other collections and visualizations of data via their respective computing devices 16. This may include data from any of a wide variety of sources, including from multidimensional data structures and relational databases within enterprise 4, as well as data from a variety of external sources that may be accessible over public network 15.

Users 12 may use a variety of different types of computing devices 16 to interact with enterprise business intelligence system 14 and access data visualization tools and other resources via enterprise network 18. For example, an enterprise user 12 may interact with enterprise business intelligence system 14 and run a business intelligence (BI) portal (e.g., a business intelligence dashboard, etc.) using a laptop computer, a desktop computer, or the like, which may run a web browser. Alternatively, an enterprise user may use a smartphone, tablet computer, or similar device, running a business intelligence dashboard in a web browser, a dedicated mobile application, or other means for interacting with enterprise business intelligence system 14.

Enterprise network 18 and public network 15 may represent any communication network, and may include a packet-based digital network such as a private enterprise intranet or a public network like the Internet. In this manner, computing environment 10 can readily scale to suit large enterprises. Enterprise users 12 may directly access enterprise business intelligence system 14 via a local area network, or may remotely access enterprise business intelligence system 14 via a virtual private network, remote dial-up, or similar remote access communication mechanism.

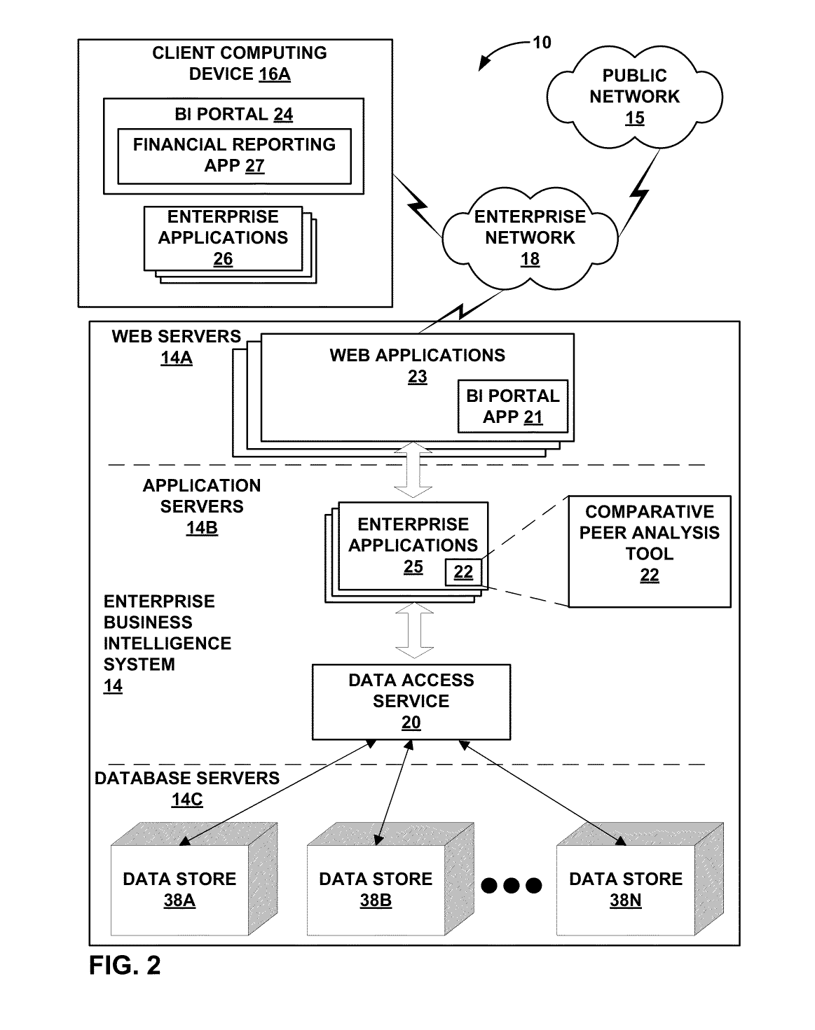

FIG. 2 is a block diagram illustrating in further detail portions of one embodiment of an enterprise business intelligence (BI) system 14. In this example implementation, a single client computing device 16A is shown for purposes of example and includes a BI portal 24 and one or more client-side enterprise software applications 26 that may utilize and manipulate multidimensional data, including to view data visualizations and analytical tools with BI portal 24. BI portal 24 may be rendered within a general web browser application, within a locally hosted application or mobile application, or other user interface. BI portal 24 may be generated or rendered using any combination of application software and data local to the computing device it's being generated on, and/or remotely hosted in one or more application servers or other remote resources.

BI portal 24 may output data visualizations for a user to view and manipulate in accordance with various techniques described in further detail below. BI portal 24 may present data in the form of charts or graphs that a user may manipulate, for example. BI portal 24 may present visualizations of data based on data from sources such as a BI report, e.g., that may be generated with enterprise business intelligence system 14, or another BI dashboard, as well as other types of data sourced from external resources through public network 15. BI portal 24 may present visualizations of data based on data that may be sourced from within or external to the enterprise.

FIG. 2 depicts additional detail for enterprise business intelligence system 14 and how it may be accessed via interaction with a BI portal 24 for depicting and providing visualizations of business data. BI portal 24 may provide visualizations of data that represents, provides data from, or links to any of a variety of types of resource, such as a BI report, a software application, a database, a spreadsheet, a data structure, a flat file, Extensible Markup Language (“XML”) data, a comma separated values (CSV) file, a data stream, unorganized text or data, or other type of file or resource. BI portal 24 may also provide visualizations of data based on comparative peer analysis generated by a comparative peer analysis tool 22.

Comparative peer analysis tool 22 may be hosted among enterprise applications 25, as in the example depicted in FIG. 2, or may be hosted elsewhere, including on a client computing device 16A, or distributed among various computing resources in enterprise business intelligence system 14, in some examples. Comparative peer analysis tool 22 may be implemented as or take the form of a stand-alone application, a portion or add-on of a larger application, a library of application code, a collection of multiple applications and/or portions of applications, or other forms, and may be executed by any one or more servers, client computing devices, processors or processing units, or other types of computing devices.

As depicted in FIG. 2, enterprise business intelligence system 14 is implemented in accordance with a three-tier architecture: (1) one or more web servers 14A that provide web applications 23 with user interface functions, including a server-side BI portal application 21; (2) one or more application servers 14B that provide an operating environment for enterprise software applications 25 and a data access service 20; and (3) database servers 14C that provide one or more data sources 38A, 38B, . . . , 38N (“data sources 38”). Enterprise software applications 25 may include authoritative peer comparison tool 22 as one of enterprise software applications 25 or as a portion or portions of one or more of enterprise software applications 25. The data sources 38 may include two-dimensional databases and/or multidimensional databases or data cubes. The data sources may be implemented using a variety of vendor platforms, and may be distributed throughout the enterprise. As one example, the data sources 38 may be multidimensional databases configured for Online Analytical Processing (OLAP). As another example, the data sources 38 may be multidimensional databases configured to receive and execute Multidimensional Expression (MDX) queries of some arbitrary level of complexity. As yet another example, the data sources 38 may be two-dimensional relational databases configured to receive and execute SQL queries, also with an arbitrary level of complexity. Data sources 38 may also include authoritative peer comparison information that may be identified, processed, and/or stored among data sources 38 by comparative peer analysis tool 22.

Multidimensional data structures are “multidimensional” in that each multidimensional data element is defined by a plurality of different object types, where each object is associated with a different dimension. The enterprise applications 26 on client computing device 16A may issue business queries to enterprise business intelligence system 14 to build reports. Enterprise business intelligence system 14 includes a data access service 20 that provides a logical interface to the data sources 38. Client computing device 16A may transmit query requests through enterprise network 18 to data access service 20. Data access service 20 may, for example, execute on the application servers intermediate to the enterprise software applications 25 and the underlying data sources in database servers 14C. Data access service 20 retrieves a query result set from the underlying data sources, in accordance with query specifications. Data access service 20 may intercept or receive queries, e.g., by way of an API presented to enterprise applications 26. Data access service 20 may then return this result set to enterprise applications 26 as BI reports, other BI objects, and/or other sources of data that are made accessible to BI portal 24 on client computing device 16A.

These BI objects or sources of data may include authoritative comparative peer analysis information generated by comparative peer analysis tool 22 for output or display in a BI report context or in association with a BI report. Comparative peer analysis tool 22 may respond to an input that may indicate one or more features of a BI report context associated with enterprise 4 with a request for comparative peer analysis of those indicated features. In particular, comparative peer analysis tool 22 may identify peer entities of enterprise 4, retrieve information associated with the peer entities from one or more authoritative information sources, identify elements of information associated with the peer entities that correspond with the indicated features of the BI report context associated with enterprise 4 from the input, and generate an output that includes those identified elements of information associated with the peer entities, as further described below. The output may be in comparison to the features of the BI report context indicated in the input.

As described above and further below, comparative peer analysis tool 22 may be implemented in one or more computing devices, and may involve one or more applications or other software modules that may be executed on one or more processors. Example embodiments of the present disclosure may illustratively be described in terms of the example of comparative peer analysis tool 22 in various examples described below.

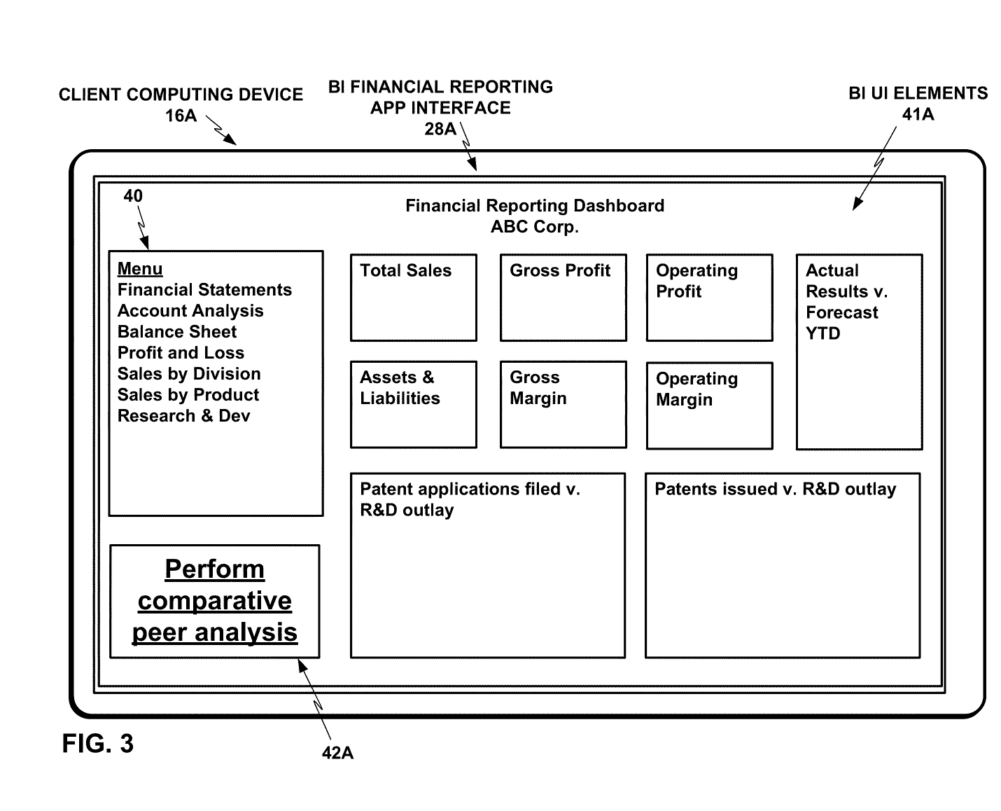

FIG. 3 shows a conceptual diagram of client computing device 16A, implemented as a tablet computer, rendering a BI financial reporting application user interface 28A for a BI financial reporting application 27 within a BI portal 24 as described above and enabled to access comparative peer analysis tool 22. Financial reporting application interface 28A may be part of computing environment 10 of enterprise 4 and may be coupled with an enterprise BI system 14 as shown in FIGS. 1 and 2. Financial reporting application interface 28A is implemented as a BI financial reporting dashboard in this example, but may take the form of any BI interface in other examples. Financial reporting application interface 28A may have a wide variety of menu options in example menu 40, and any of a wide variety of BI user interface elements 41A (e.g., graphs, charts, widgets). As shown in the example of FIG. 3, menu 40 may include menu items for financial statements, account analysis, balance sheet, etc., and BI UI elements 41A may include UI elements for total sales, gross profit, operating profit, etc. as shown in FIG. 3, each of which may be rich with applicable information.

Financial reporting application interface 28A also includes a comparative peer analysis UI element 42A (e.g., a graphically rendered UI button) for the user to select an option (e.g., by touching, pressing, or clicking on UI element 42A) to select a comparative peer analysis on information represented in BI UI elements 41A or other elements of financial reporting application interface 28A. When a user selects comparative peer analysis UI element 42A in financial reporting application interface 28A, financial reporting application 27 may communicate a request for a comparative peer analysis to comparative peer analysis tool 22 as shown in FIG. 2 and as described above.

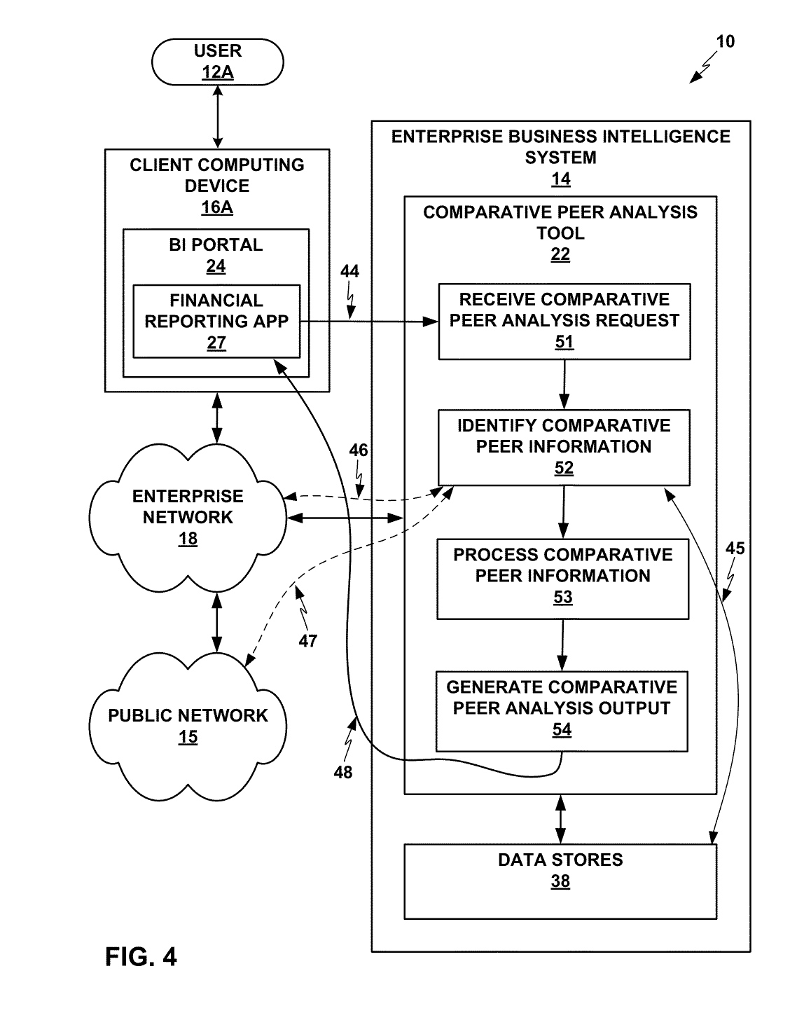

Financial reporting application 27 may also communicate information about a current BI report context along with the request, such as features associated with the BI UI elements 41A the user is viewing in financial reporting application interface 28A when the user selects comparative peer analysis UI element 42A. In another example, financial reporting application interface 28A may be configured to enable the user to select one or more specific BI UI elements 41A in conjunction with selecting comparative peer analysis UI element 42A. For example, the user may first make an initial selection of comparative peer analysis UI element 42A, which may prompt the user to select one or more of BI UI elements 41A to include in the comparative peer analysis. The user may then select or indicate one or more of BI UI elements 41A, and then, e.g., select comparative peer analysis UI element 42A again to confirm those selected BI UI elements 41A as the applicable BI report context to send with the request. Financial reporting application 27 may then respond to the user inputs to comparative peer analysis UI element 42A and BI UI elements 41A to communicate the comparative peer analysis request along with the selected or indicated features of the applicable BI report context associated with enterprise 4 to comparative peer analysis tool 22, as shown in FIG. 4.

FIG. 4 shows a conceptual block diagram of computing environment 10 in which comparative peer analysis tool 22 responds to an input 44 from financial reporting application 27 requesting comparative peer analysis of indicated features of a BI report context associated with enterprise 4. In various examples, BI report context may include BI features indicated by the complete set of BI UI elements 41A shown in BI financial reporting application interface 28A shown in FIG. 3, or the particular BI features indicated by the BI UI elements 41A selected via user inputs, as described above. Computing environment 10 may be a different view of the same computing environment 10 shown in FIGS. 1 and 2, showing additional detail of the interaction and function of comparative peer analysis tool 22 in some examples. Comparative peer analysis tool 22 is depicted with example details of its functions depicted as functional units 51-54, which may represent software modules or libraries executing on one or more processors of BI application servers 14B, for example. Additional example details are discussed further below.

Financial reporting application 27 may communicate input 44 with a comparative peer analysis request (e.g., via enterprise network 18, enterprise BI web servers 14A, and enterprise BI application servers 14B), along with the indicated features of the applicable BI report context associated with enterprise 4 as indicated by the user in financial reporting application interface 28A, to comparative peer analysis tool 22. Comparative peer analysis tool 22 may be configured with a functional unit 51 for receiving the comparative peer analysis request, a functional unit 52 for identifying comparative peer information, a functional unit 53 for processing or consolidating comparative peer information, and a functional unit 54 for generating a comparative peer analysis output. The comparative peer information may include one or more elements of information associated with one or more peer entities of the enterprise 4 from one or more authoritative information sources, wherein the one or more elements of information associated with one or more peer entities correspond with the one or more indicated features of the BI report context. In some examples, processing or consolidating comparative peer information 53 may be included as part of identifying the comparative peer information and/or as part of generating the comparative peer analysis output 54. These functional units 51-54 of comparative peer analysis tool 22 are further described as follows.

When executing functional unit 52, comparative peer analysis tool 22 may, in response to the input communicated via comparative peer analysis request 44 (e.g., receiving functional unit 51) indicating one or more features of a BI report context associated with enterprise 4, identify information associated with one or more peer entities of enterprise 4 from one or more authoritative information sources. In particular, comparative peer analysis tool 22 may identify specific elements of information associated with one or more peer entities that correspond with the one or more indicated features of the BI report context.

Comparative peer analysis tool 22 may in some examples initially identify one or more peer entities of the enterprise prior to identifying the information associated with peer entities. The first time comparative peer analysis tool 22 is executed, it may perform a new identification of one or more peer entities of the enterprise, and may save this information for future use. In subsequent use, comparative peer analysis tool 22 may identify the peer entities of the enterprise by referring to or accessing the stored results of an earlier determination, or may modify the earlier identification with updated information or perform a new identification of peer entities. In some examples, the user may also designate one or more peer entities as part of the input to request the comparative peer analysis, and comparative peer analysis tool 22 may identify the designated peer entities in the input, in addition to or instead of performing another independent identification of peer entities.

Comparative peer analysis tool 22 may also have a designated set of authoritative information sources from which it accesses or searches for information about the peer entities. In some examples, comparative peer analysis tool 22 may draw information on the peer entities primarily from data stores 38 from within enterprise BI system 14 (depicted in FIG. 4 as communications 45 between functional block 52 of comparative peer analysis tool 22 and data stores 38), where such information may already be collected and organized. In some examples, comparative peer analysis tool 22 may draw information on the peer entities from elsewhere in enterprise network 18 (e.g., communications 46) or from external sources via public network 15 (e.g., the Internet) (e.g., communications 47). In some examples, comparative peer analysis tool 22 may perform an initial collection of information from data stores 38, and then evaluate whether it should collect additional information, and if so, then determining where to search for additional information among authoritative information sources via enterprise network 18 and/or public network 15. Authoritative information sources as recognized by comparative peer analysis tool 22 are further described below.

For purposes of this disclosure, identifying information may include performing a search for the information, receiving the information as a result of a search, retrieving the information from a database or other data store, loading the information into a memory component, copying the information onto a data storage device, loading the information into a namespace, or assigning the information to an object or variable, for example. Thus, comparative peer analysis tool 22 may identify elements of information associated with peer entities of the enterprise from authoritative information sources, wherein the elements of information correspond with the indicated features of the BI report context, by performing a search for the elements of information, retrieving the elements of information from a database, or identifying the elements of information according to any of the other examples given above, among other applicable examples.

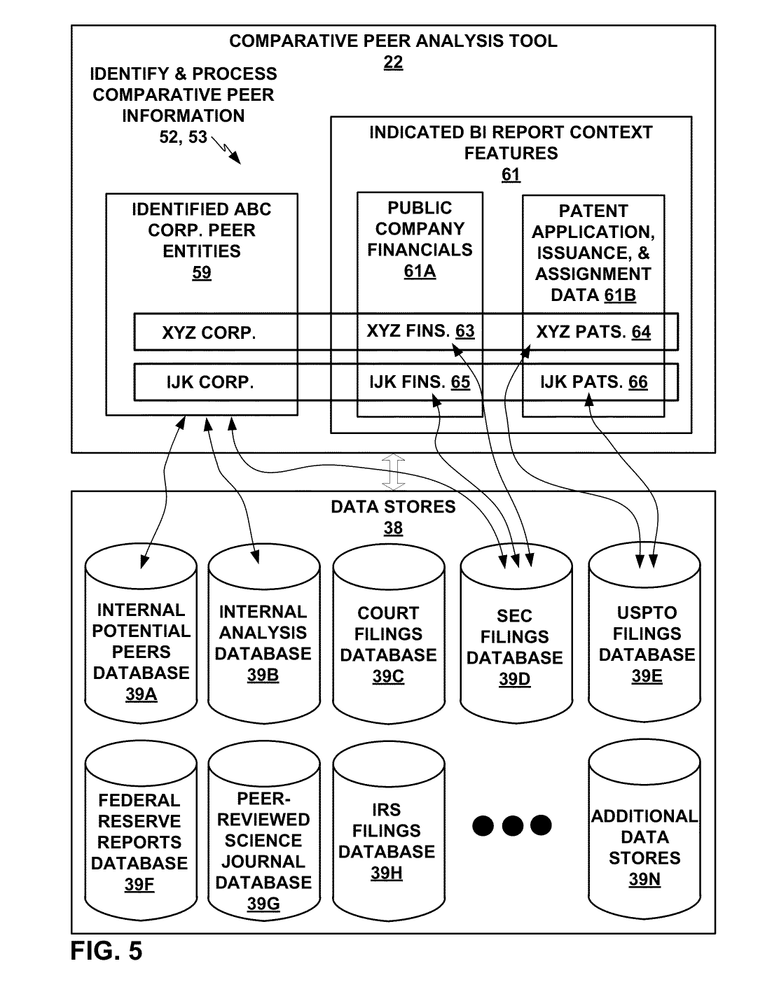

After or as part of identifying the elements of information on peer entities that correspond with the indicated features of the BI report context, comparative peer analysis tool 22 may process or consolidate the comparative peer information, e.g., the identified elements of information associated with peer entities of the enterprise from authoritative information sources, wherein the elements of information correspond with the indicated features of the BI report context. Processing or consolidating the comparative peer information may include isolating specific elements of information that directly correspond with the indicated features of the BI report context from larger sources of information. Identifying and processing the comparative peer information is further described below with reference to FIGS. 5-8.

Comparative peer analysis tool 22 may also execute functional block 54 to generate an output 48 comprising the one or more elements of information associated with the one or more peer entities that correspond with the one or more indicated features of the BI report context associated with the enterprise, as comparative peer analysis tool 22 has identified the comparative peer information. This may also be referred to as generating the comparative peer analysis output. Processing or consolidating the comparative peer information, and/or generating the comparative peer analysis output, may include converting the information into a data format suitable for the output. Generating the comparative peer analysis output may also include ensuring that a corresponding element of information associated with each of the one or more applicable peer entities has been identified and prepared for the output to correspond with each of the one or more indicated features of the BI report context, or at least as far as possible (within a given nominal standard). Generating the comparative peer analysis output may also include comparative peer analysis tool 22 communicating the output 48 (e.g., with the elements of information associated with the peer entities that correspond with the one or more indicated features of the BI report context associated with the enterprise) to financial reporting application 27 executing on client computing device 16A. Generating the output is further described below with reference to FIGS. 5-8.

FIG. 5 depicts an example conceptual block diagram of comparative peer analysis tool 22 interacting with data stores 38 and identifying and processing comparative peer information 52, 53 for a comparative peer analysis. Generally, comparative peer analysis tool 22 may identify peer entities 59 of enterprise 4 (“ABC Corp.”); may load or access indicated BI report context features 61 from the input requesting the comparative peer analysis; and may access authoritative information sources such as databases 39A, 39B, . . . , 39N (“databases 39A-N”) among data stores 38. The indicated BI report context features 61 may be accessed from the input requesting the comparative peer analysis.

Based on the example BI UI elements 41A of BI financial reporting application interface 28A of the example of FIG. 3, the indicated BI report context features 61 may include public company financial information 61A, and patent application, issuance, and assignment data 61B, for example. In other examples, the indicated features of the BI report context may include information on financial markets, international trade volumes, commodity flows, educational performance, legal proceedings, energy usage, public health measures, population demographics, environmental performance, natural resource protection, investment flows among asset classes, or any of a wide variety of any other kinds of information applicable or relevant to enterprises of any kind.

Data stores 38 in this example include authoritative information sources such as internal potential peers database 39A, internal analysis database 39B, court filings database 39C, Securities and Exchange Commission (SEC) filings database 39D, U.S. Patent and Trademark Office (USPTO) filings database 39E, Federal Reserve reports database 39F, peer-reviewed science journal database 39G, Internal Revenue Service (IRS) filings database 39H, and further including any of a wide variety of additional data stores 39N. While reference is made here to various U.S. entities, data stores 38 may also or instead include information sources from analogous agencies or entities from any other nations or organizations. Additional authoritative information sources may include reports or publications from authoritative international organizations such as the Organization for Economic Cooperation and Development (OECD), the International Monetary Fund (IMF), the World Bank, the Bank for International Settlements (BIS), the International Energy Agency (IEA), or the World Health Organization (WHO), for example. Identifying the elements of information associated with the peer entities from the authoritative information sources may thus include retrieving at least one of: a filing reported to a securities regulating agency; a filing reported to a tax agency; a filing submitted to a court of law; a research paper from a recognized academic research journal; a publication of a government entity; a publication of a recognized non-government organization; a publication of a recognized economic organization; a publication of a recognized research organization; or an internal analysis performed within the enterprise, such as in the examples of databases 39A-N.

Comparative peer analysis tool 22 may also identify the authoritative information sources as they pertain to the peer entities, prior to identifying the elements of information associated with the peer entities from the one or more authoritative information sources. Identifying the authoritative information sources as they pertain to the peer entities may include identifying one or more sources of information that are from a predefined set of authoritative sources, or that have confirmable characteristics of authoritativeness in some examples, and that are indicated to comprise information pertaining to the one or more peer entities. Comparative peer analysis tool 22 may store the predefined set of authoritative sources, which may be limited to a defined set such as those shown in databases 39A-N in FIG. 5 or with a limited additional number of information sources well-known to be authoritative, for example. Identifying a source of information that has confirmable characteristics of authoritativeness may include identifying a weighted minimum number of citations to the source among the sources of information in the predefined set of authoritative sources. The weighted minimum number of citations may be weighted according to how authoritative the citing source may be, such that a citation by an especially respected, prestigious, or authoritative source may be counted for a higher portion of the minimum number of citations needed to establish authoritativeness than a citation by a lesser authoritative source. Thus, for example, comparative peer analysis tool 22 may identify a large number of references and other citations among a wide variety of its authoritative sources to another source of information on one or more of the peer entities and on point with the indicated features of information from the BI report context, and if the citations meet the weighted threshold, comparative peer analysis tool 22 may retrieve selected information from the cited source.

Comparative peer analysis tool 22 may identify peer entities of enterprise 4, prior to identifying the one or more elements of information associated with one or more peer entities of the enterprise. To identify the peer entities, comparative peer analysis tool 22 may access or load the identities of peer entities from memory within its own resources, or may access or load the identities of peer entities from an internal potential peers database 39A among data stores 38, as shown in FIG. 5, in various examples. Comparative peer analysis tool 22 may curate internal potential peers database 39A, such as by initially storing information on peer entities and potential peer entities based on its results in internal potential peers database 39A, and then later modifying or updating information on peer entities and potential peer entities based on its subsequent results in internal potential peers database 39A.

Comparative peer analysis tool 22 may also access other authoritative information sources such as internal analysis database 39B or SEC filings database 39D, as shown in FIG. 5, to assemble information to identify peer entities of enterprise 4. In some examples, comparative peer analysis tool 22 or other tools, applications, or processes of enterprise BI system 14 may, periodically or as prompted by inputs from financial reporting application 27, access external data sources directly from Internet-connected resources of the SEC (e.g., the SEC “Edgar” filings website) and store and/or curate the acquired SEC data in SEC filings database 39D.

In some examples, to identify peer entities of enterprise 4, comparative peer analysis tool 22 may apply rules for identifying one or more entities with comparable categorical status to the enterprise and comparable metrics to the enterprise. Identifying entities with comparable categorical status may, for example, include identifying enterprise 4 as a Fortune 500 company in the technology sector, as an example of applying rules for identifying the categorical status of enterprise 4. In other examples, applying rules to identify entities with comparable categorical status may include identifying the enterprise as a high-growth developing nation as a categorical status and identifying other high-growth developing nations as peer entities, or identifying the enterprise as a mid-size regional American bank as a categorical status and identifying other mid-size regional American banks as peer entities.

Applying rules to identify entities with comparable metrics may include filtering by a range of revenues, net profits, population size, or number of registered users, for example. In one example, identifying entities with both comparable categorical status and comparable metrics to the enterprise may include identifying the enterprise as a U.S. financial company with annual revenues of between one and ten billion U.S. dollars, and identifying other U.S. financial companies with annual revenues of between one and ten billion U.S. dollars as peer entities of the enterprise.

Comparative peer analysis tool 22 may identify “XYZ Corp.” and “IJK Corp.” as peer entities 59 of enterprise 4. While enterprise 4 and its peer entities are corporations in this example, the enterprise and its peer entities may also be governments, government agencies, international organizations, educational institutions, healthcare providers, non-profit organizations, or any other kind of enterprises in other examples.

In the example of FIG. 5, comparative peer analysis tool 22 may identify the public company financial information 61A and patent information 61B of identified peer entities 59 as the specific indicated features of the BI report context associated with enterprise 4. In particular, comparative peer analysis tool 22 may specifically identify the elements of peer entity information corresponding to the indicated features of the BI report context as the intersections of the indicated features of public company financial information 61A and patent information 61B and information on the identified peer entities 59, “XYZ Corp.” and “IJK Corp.” Comparative peer analysis tool 22 may thus specify the need to identify XYZ's financial information 63, XYZ's patent information 64, IJK's financial information 65, and IJK's patent information 66.

Comparative peer analysis tool 22 may then search in or access SEC filings database 39D to retrieve XYZ's financial information 63 and IJK's financial information 65, as shown in FIG. 5. This may include accessing and loading specific information such as total sales, gross profit, operating profit, research and development (R&D) or internal research and development (IRAD) budgets, and other information for each year of a long range of time for each of the peer entities XYZ and IJK. Comparative peer analysis tool 22 may also search in or access USPTO filings database 39E to retrieve XYZ's patent information 64 and IJK's patent information 66, potentially including information such as the number, titles, inventors, complete specifications, image file wrappers, etc. of all publicly accessible patents and patent applications for each year of a long range of time for each of the peer entities XYZ and IJK.

Identifying the elements of information associated with the one or more peer entities that correspond with the one or more indicated features of the BI report context associated with the enterprise may include identifying one or more parameters of the indicated features of the BI report context, and searching for information about the peer entity that corresponds to the one or more parameters of the indicated features of the BI report context. For example, the parameters may include a selected range of time, such as a certain range of years, for several indicated features of the BI report context involving financial results. Comparative peer analysis tool 22 may then only seek financial information on the peer entities for the selected range of years, or may eliminate information from outside the selected range of years as part of identifying the applicable information and/or as part of generating the corresponding output. In another example, the parameters may include a selected division or technology area of the enterprise, and comparative peer analysis tool 22 may seek to assemble corresponding elements of financial, market, and patent information only from a comparable division or comparable technology area of the peer entities, thereby defining the applicable peer entities more narrowly in accordance with the parameters of the input.

Comparative peer analysis tool 22 may then generate the applicable output containing the elements of information specified to correspond to the indicated features of the BI report context from the request input. This may include assembling only certain information from among the information received from searches performed, and may also include combining data from different authoritative information sources in novel formats to correspond to the indicated features of the BI report context from the request input. As an example of assembling only certain information from among the information received from searches performed, comparative peer analysis tool 22 may assemble certain financial information on the peer entities such as total sales, gross profit, operating profit, etc., while removing certain other financial information received as search results from SEC filings database 39D but not indicated among the features of the BI report context from the request input, such as information on officer compensation or currency hedges, for example.

As an example of combining data from different authoritative information sources in novel formats to correspond to the indicated features of the BI report context from the request input, comparative peer analysis tool 22 may determine total numbers of patent applications filed and patents issued per year for each of XYZ Corp. and IJK Corp. from information retrieved from USPTO filings database 39E, and determine R&D outlays per year from each of XYZ Corp. and IJK Corp. from information retrieved from SEC filings database 39D, and combine this information on patents and R&D outlays. Comparative peer analysis tool 22 may then format the combined elements of information on patents and R&D outlays for the peer entities for output suited for BI UI elements that directly correspond to the indicated features of the BI report context from the request input.

In various examples, identifying the elements of information associated with the peer entities from the authoritative information sources may include identifying any one or more of financial data, numerical data, scientific data, and text associated with the one or more peer entities from the one or more authoritative information sources; identifying one or more parameters of the one or more of the financial data, numerical data, scientific data, or text associated with the peer entities from the authoritative information sources; and identifying contextual information associated with the financial data, numerical data, scientific data, or text associated with the one or more peer entities. The parameters may include date ranges, geographical limitations, limitations to one or more selected nations, company divisions, or product lines, or other selected divisions of applicable data, for example. Contextual information may include metadata or information about the authoritative information sources from which comparative peer analysis tool 22 draws its information, for example.

Comparative peer analysis tool 22 may also perform one or more of structured querying, indexing, sorting, and text mining of the financial data, numerical data, scientific data, or text associated with the one or more peer entities. For example, comparative peer analysis tool 22 may perform structured queries of data in databases, may index data from information sources and refer to the index when searching for applicable information, may sort information from multiple information sources according to a unified timeframe, and may mine text from large bodies of SEC filings or science journal articles to isolate and edit only elements of information directly applicable to indicated features of a BI report context from a request input. Identifying elements of information associated with the peer entities from the authoritative information sources where the elements of information correspond with the indicated features of the BI report context may also include comparing the indicated features of the BI report context with the identified contextual information associated with the one or more of the financial data, numerical data, scientific data, or text associated with the peer entities, such as only comparing information between the enterprise and the peer entities within a selected range of years, for example.

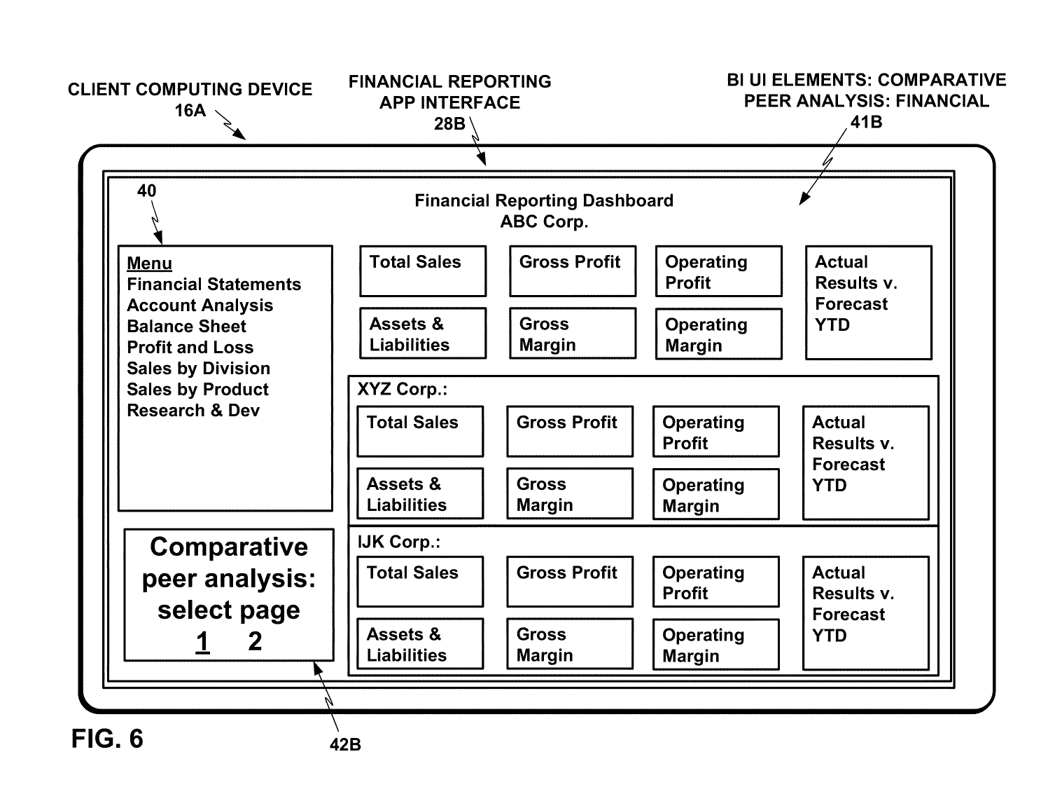

FIG. 6 shows a conceptual diagram of client computing device 16A rendering a BI financial reporting application user interface 28B after BI financial reporting application 27 has received an output generated by comparative peer analysis tool 22, in one example. BI financial reporting application user interface 28B shows BI UI elements 41B that include a portion of results from the comparative peer analysis performed by comparative peer analysis tool 22, directed to financial elements of information for the peer entities that correspond to matching features of the BI report context indicated in the input from the enterprise's own information, also displayed among BI UI elements 41B.

Thus, BI financial reporting application user interface 28B with the output from comparative peer analysis tool 22 displays financial information from the enterprise 4, ABC Corp., side-by-side on the display screen with corresponding financial information from ABC's peer entities, XYZ and IJK. BI financial reporting application user interface 28B also shows comparative peer analysis UI element 42B with navigation options for selecting between multiple pages or views of comparative information showing information for the enterprise ABC side-by-side with corresponding elements of information for ABC's peer entities XYZ and IJK for all features of the BI reporting context indicated in the input.

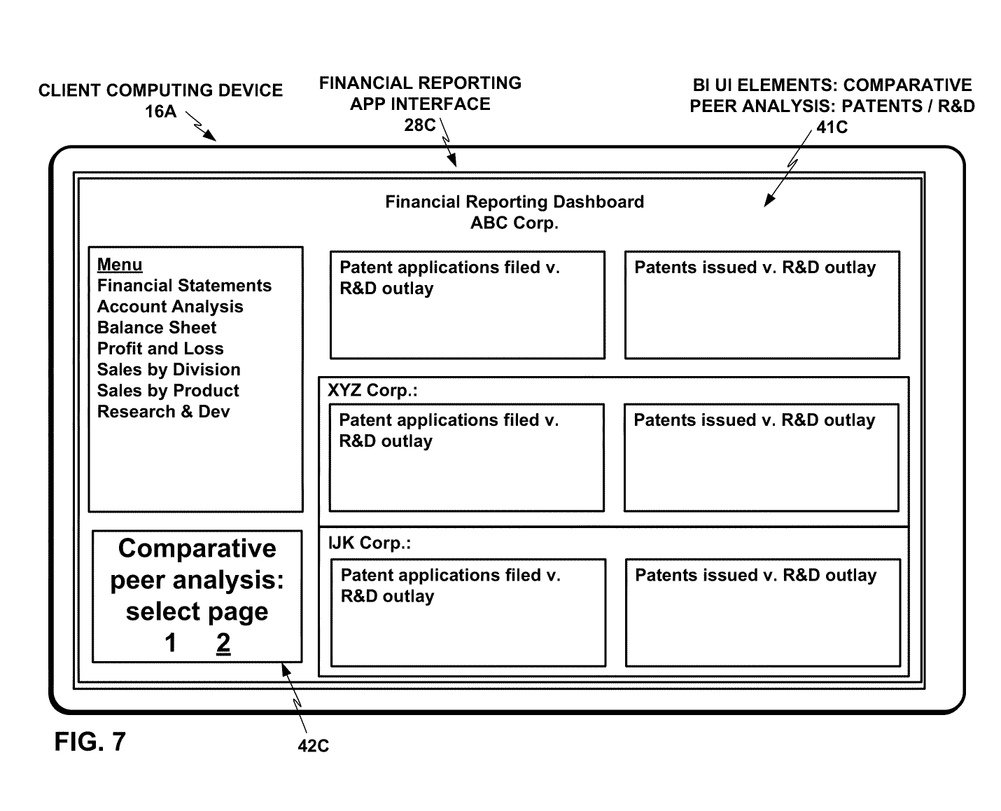

FIG. 7 shows a conceptual diagram of client computing device 16A rendering a BI financial reporting application user interface 28C, also after BI financial reporting application 27 has received an output generated by comparative peer analysis tool 22, in one example. In one example, a user may navigate among BI financial reporting application user interfaces 28B and 28C of FIGS. 6 and 7 using comparative peer analysis navigation feature 42B/42C as shown in FIGS. 6 and 7. BI financial reporting application user interface 28C shows BI UI elements 41C that include another portion of results from the comparative peer analysis performed by comparative peer analysis tool 22, directed to elements of information on patents and R&D outlays for the peer entities that correspond to matching features of the BI report context indicated in the input from the enterprise's own information, also displayed among BI UI elements 41C.

These elements of information on patents and R&D outlays for the peer entities may result from the comparative peer analysis tool 22 performing its own consolidation of applicable elements of information as part of generating its output, as described above. In this example as in a variety of other examples, such a novel assembly of applicable elements of information from various sources into one representation or one view that facilitates analysis by the user may be referred to as analysis representation. Thus, generating the output comprising the one or more elements of information associated with the one or more peer entities that correspond with the one or more indicated features of the BI report context associated with the enterprise may include generating an analysis representation of the one or more elements of information associated with the one or more peer entities, and including the analysis representation of the information associated with the one or more peer entities in the output. Generating the output including the elements of information associated with the peer entities that correspond with the one indicated features of the BI report context associated with the enterprise, such as by comparative peer analysis tool 22, may therefore include generating a display output for display in BI financial reporting application user interface 28B/28C, such that the display output includes a visual comparison of the elements of information associated with the one or more peer entities with the corresponding indicated features of the BI report context, as in FIGS. 6 and 7.

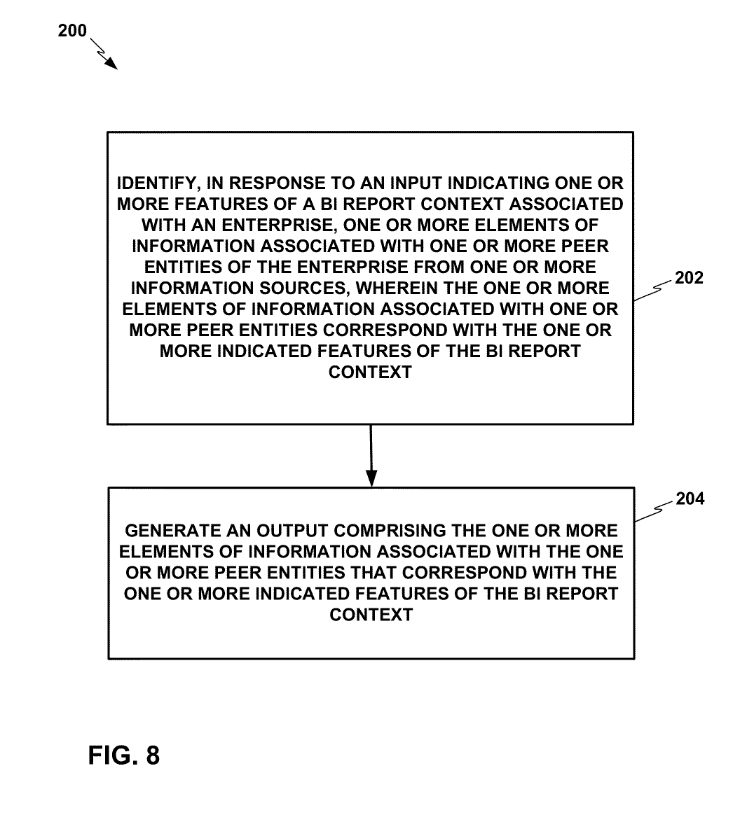

FIG. 8 shows a flowchart for an example process 200 that comparative peer analysis tool 22 executing on one or more computing devices (e.g., servers, computers, processors, etc.) of an enterprise BI system may perform. Comparative peer analysis tool 22 (e.g., as shown in FIGS. 1, 2, 4, and 5) may identify (e.g., functions 52, 53 of FIG. 4), in response to an input (e.g., input 44 prompted with comparative peer analysis UI element 42A) indicating one or more features of a BI report context associated with an enterprise (e.g., a selected one or more BI features corresponding to one or more of BI UI elements 41A), one or more elements of information (e.g., selected elements of peer entity information 63-66 shown in FIG. 5) associated with one or more peer entities of the enterprise from one or more information sources (e.g., authoritative information sources 39A-N shown in FIG. 5), wherein the one or more elements of information associated with one or more peer entities correspond with the one or more indicated features of the BI report context (202). Comparative peer analysis tool 22 may generate (e.g., functions 53, 54 of FIG. 4) an output (e.g., output 48, as rendered in BI financial reporting application interfaces 28B, 28C shown in FIGS. 6 and 7) comprising the one or more elements of information associated with the one or more peer entities that correspond with the one or more indicated features of the BI report context (204). Comparative peer analysis tool 22 may further execute any of the processes or techniques described above.

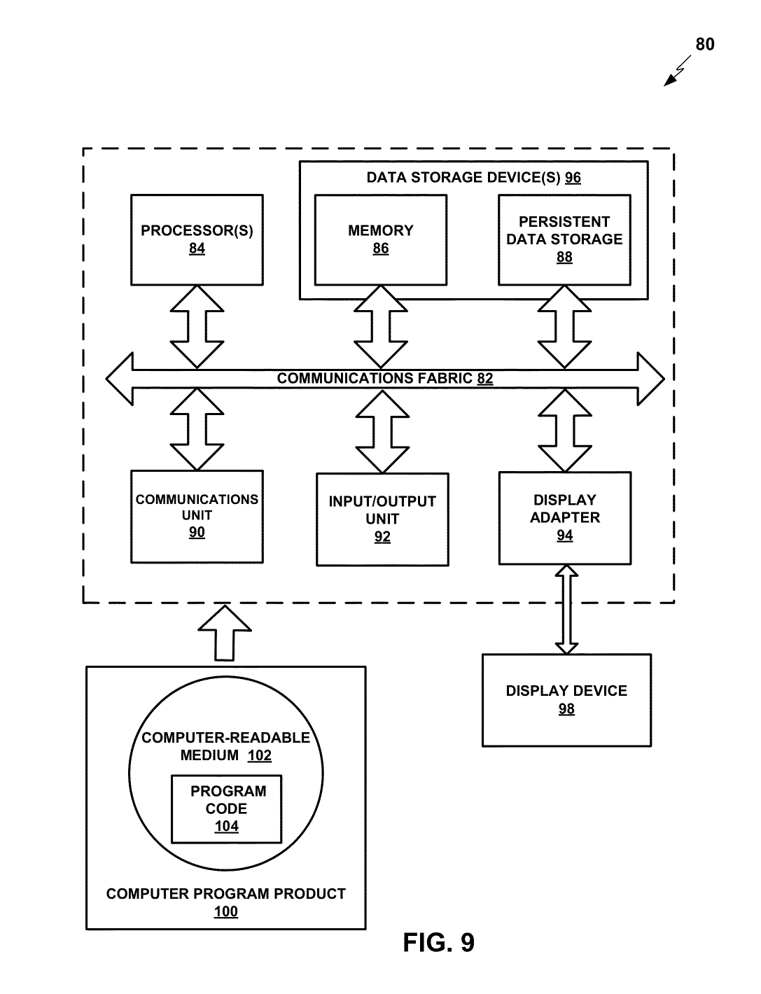

FIG. 9 is a block diagram of a computing device 80 that may be used to execute a comparative peer analysis tool 22, according to an illustrative example. Computing device 80 may be a server such as one of web servers 14A or application servers 14B as depicted in FIG. 2. Computing device 80 may also be any server for providing an enterprise business intelligence application in various examples, including a virtual server that may be run from or incorporate any number of computing devices. A computing device may operate as all or part of a real or virtual server, and may be or incorporate a workstation, server, mainframe computer, notebook or laptop computer, desktop computer, tablet, smartphone, feature phone, or other programmable data processing apparatus of any kind. Other implementations of a computing device 80 may include a computer having capabilities or formats other than or beyond those described herein.

In the illustrative example of FIG. 9, computing device 80 includes communications fabric 82, which provides communications between processor unit 84, memory 86, persistent data storage 88, communications unit 90, and input/output (I/O) unit 92. Communications fabric 82 may include a dedicated system bus, a general system bus, multiple buses arranged in hierarchical form, any other type of bus, bus network, switch fabric, or other interconnection technology. Communications fabric 82 supports transfer of data, commands, and other information between various subsystems of computing device 80.

Processor unit 84 may be a programmable central processing unit (CPU) configured for executing programmed instructions stored in memory 86. In another illustrative example, processor unit 84 may be implemented using one or more heterogeneous processor systems in which a main processor is present with secondary processors on a single chip. In yet another illustrative example, processor unit 84 may be a symmetric multi-processor system containing multiple processors of the same type. Processor unit 84 may be a reduced instruction set computing (RISC) microprocessor such as a PowerPC® processor from IBM® Corporation, an x86 compatible processor such as a Pentium® processor from Intel® Corporation, an Athlon® processor from Advanced Micro Devices® Corporation, or any other suitable processor. In various examples, processor unit 84 may include a multi-core processor, such as a dual core or quad core processor, for example. Processor unit 84 may include multiple processing chips on one die, and/or multiple dies on one package or substrate, for example. Processor unit 84 may also include one or more levels of integrated cache memory, for example. In various examples, processor unit 84 may comprise one or more CPUs distributed across one or more locations.

Data storage 96 includes memory 86 and persistent data storage 88, which are in communication with processor unit 84 through communications fabric 82. Memory 86 can include a random access semiconductor memory (RAM) for storing application data, i.e., computer program data, for processing. While memory 86 is depicted conceptually as a single monolithic entity, in various examples, memory 86 may be arranged in a hierarchy of caches and in other memory devices, in a single physical location, or distributed across a plurality of physical systems in various forms. While memory 86 is depicted physically separated from processor unit 84 and other elements of computing device 80, memory 86 may refer equivalently to any intermediate or cache memory at any location throughout computing device 80, including cache memory proximate to or integrated with processor unit 84 or individual cores of processor unit 84.

Persistent data storage 88 may include one or more hard disc drives, solid state drives, flash drives, rewritable optical disc drives, magnetic tape drives, or any combination of these or other data storage media. Persistent data storage 88 may store computer-executable instructions or computer-readable program code for an operating system, application files comprising program code, data structures or data files, and any other type of data. These computer-executable instructions may be loaded from persistent data storage 88 into memory 86 to be read and executed by processor unit 84 or other processors. Data storage 96 may also include any other hardware elements capable of storing information, such as, for example and without limitation, data, program code in functional form, and/or other suitable information, either on a temporary basis and/or a permanent basis.

Persistent data storage 88 and memory 86 are examples of physical, tangible, non-transitory computer-readable data storage devices. Data storage 96 may include any of various forms of volatile memory that may require being periodically electrically refreshed to maintain data in memory, while those skilled in the art will recognize that this also constitutes an example of a physical, tangible, non-transitory computer-readable data storage device. Executable instructions may be stored on a non-transitory medium when program code is loaded, stored, relayed, buffered, or cached on a non-transitory physical medium or device, including if only for only a short duration or only in a volatile memory format.

Processor unit 84 can also be suitably programmed to read, load, and execute computer-executable instructions or computer-readable program code for a comparative peer analysis tool 22, as described in greater detail above. This program code may be stored on memory 86, persistent data storage 88, or elsewhere in computing device 80. This program code may also take the form of program code 104 stored on computer-readable medium 102 comprised in computer program product 100, and may be transferred or communicated, through any of a variety of local or remote means, from computer program product 100 to computing device 80 to be enabled to be executed by processor unit 84, as further explained below.

The operating system may provide functions such as device interface management, memory management, and multiple task management. The operating system can be a Unix based operating system such as the AIX® operating system from IBM® Corporation, a non-Unix based operating system such as the Windows® family of operating systems from Microsoft® Corporation, a network operating system such as JavaOS® from Oracle® Corporation, or any other suitable operating system. Processor unit 84 can be suitably programmed to read, load, and execute instructions of the operating system.

Communications unit 90, in this example, provides for communications with other computing or communications systems or devices. Communications unit 90 may provide communications through the use of physical and/or wireless communications links. Communications unit 90 may include a network interface card for interfacing with a LAN 16, an Ethernet adapter, a Token Ring adapter, a modem for connecting to a transmission system such as a telephone line, or any other type of communication interface. Communications unit 90 can be used for operationally connecting many types of peripheral computing devices to computing device 80, such as printers, bus adapters, and other computers. Communications unit 90 may be implemented as an expansion card or be built into a motherboard, for example.

The input/output unit 92 can support devices suited for input and output of data with other devices that may be connected to computing device 80, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 92 may also include any type of interface for video output in any type of video output protocol and any type of monitor or other video display technology, in various examples. It will be understood that some of these examples may overlap with each other, or with example components of communications unit 90 or data storage 96. Input/output unit 92 may also include appropriate device drivers for any type of external device, or such device drivers may reside elsewhere on computing device 80 as appropriate.

Computing device 80 also includes a display adapter 94 in this illustrative example, which provides one or more connections for one or more display devices, such as display device 98, which may include any of a variety of types of display devices. It will be understood that some of these examples may overlap with example components of communications unit 90 or input/output unit 92. Input/output unit 92 may also include appropriate device drivers for any type of external device, or such device drivers may reside elsewhere on computing device 80 as appropriate. Display adapter 94 may include one or more video cards, one or more graphics processing units (GPUs), one or more video-capable connection ports, or any other type of data connector capable of communicating video data, in various examples. Display device 98 may be any kind of video display device, such as a monitor, a television, or a projector, in various examples.

Input/output unit 92 may include a drive, socket, or outlet for receiving computer program product 100, which comprises a computer-readable medium 102 having computer program code 104 stored thereon. For example, computer program product 100 may be a CD-ROM, a DVD-ROM, a Blu-Ray disc, a magnetic disc, a USB stick, a flash drive, or an external hard disc drive, as illustrative examples, or any other suitable data storage technology.

Computer-readable medium 102 may include any type of optical, magnetic, or other physical medium that physically encodes program code 104 as a binary series of different physical states in each unit of memory that, when read by computing device 80, induces a physical signal that is read by processor 84 that corresponds to the physical states of the basic data storage elements of storage medium 102, and that induces corresponding changes in the physical state of processor unit 84. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of processor unit 84, thereby physically causing or configuring processor unit 84 to generate physical outputs that correspond to the computer-executable instructions, in a way that causes computing device 80 to physically assume new capabilities that it did not have until its physical state was changed by loading the executable instructions comprised in program code 104.

In some illustrative examples, program code 104 may be downloaded over a network to data storage 96 from another device or computer system for use within computing device 80. Program code 104 comprising computer-executable instructions may be communicated or transferred to computing device 80 from computer-readable medium 102 through a hard-line or wireless communications link to communications unit 90 and/or through a connection to input/output unit 92. Computer-readable medium 102 comprising program code 104 may be located at a separate or remote location from computing device 80, and may be located anywhere, including at any remote geographical location anywhere in the world, and may relay program code 104 to computing device 80 over any type of one or more communication links, such as the Internet and/or other packet data networks. The program code 104 may be transmitted over a wireless Internet connection, or over a shorter-range direct wireless connection such as wireless LAN, Bluetooth™, Wi-Fi™, or an infrared connection, for example. Any other wireless or remote communication protocol may also be used in other implementations.

The communications link and/or the connection may include wired and/or wireless connections in various illustrative examples, and program code 104 may be transmitted from a source computer-readable medium 102 over non-tangible media, such as communications links or wireless transmissions containing the program code 104. Program code 104 may be more or less temporarily or durably stored on any number of intermediate tangible, physical computer-readable devices and media, such as any number of physical buffers, caches, main memory, or data storage components of servers, gateways, network nodes, mobility management entities, or other network assets, en route from its original source medium to computing device 80.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of comparative peer analysis for business intelligence (BI), the method comprising:
identifying, by one or more processors, in response to an input indicating one or more features of a BI report context associated with an enterprise, one or more elements of information associated with one or more peer entities of the enterprise from one or more information sources, wherein the one or more elements of information associated with one or more peer entities correspond with the one or more indicated features of the BI report context; and
generating, by the one or more processors, an output comprising the one or more elements of information associated with the one or more peer entities that correspond with the one or more indicated features of the BI report context.

2. The method of claim 1, wherein identifying the one or more elements of information associated with the one or more peer entities that correspond with the one or more indicated features of the BI report context comprises:
identifying one or more parameters of the one or more indicated features of the BI report context; and
searching for information about the one or more peer entities that corresponds to the one or more parameters of the one or more indicated features of the BI report context.

3. The method of claim 1, wherein generating the output comprising the one or more elements of information associated with the one or more peer entities that correspond with the one or more indicated features of the BI report context comprises:
generating an analysis representation of the one or more elements of information associated with the one or more peer entities; and
including the analysis representation of the information associated with the one or more peer entities in the output.

4. The method of claim 1, wherein identifying the one or more elements of information associated with the one or more peer entities from the one or more information sources comprises:
identifying one or more of: financial data, numerical data, scientific data, or text associated with the one or more peer entities from the one or more information sources;
identifying one or more parameters of the one or more of the financial data, numerical data, scientific data, or text associated with the one or more peer entities from the one or more information sources; and
identifying contextual information associated with the one or more of the financial data, numerical data, scientific data, or text associated with the one or more peer entities.

5. The method of claim 4, further comprising performing one or more of structured querying, indexing, sorting, and text mining of the financial data, numerical data, scientific data, or text associated with the one or more peer entities.

6. The method of claim 4, wherein identifying the one or more elements of information associated with one or more peer entities of the enterprise from the one or more information sources, wherein the one or more elements of information associated with one or more peer entities correspond with the one or more indicated features of the BI report context, comprises:
comparing the one or more indicated features of the BI report context with the identified contextual information associated with the one or more of the financial data, numerical data, scientific data, or text associated with the one or more peer entities.

7. The method of claim 1, wherein identifying the one or more elements of information associated with the one or more peer entities from the one or more information sources comprises retrieving at least one of: a filing reported to a securities regulating agency, a filing reported to a tax agency, a filing submitted to a court of law, a research paper from a recognized academic research journal, a publication of a government entity, a publication of a recognized non-government organization, a publication of a recognized economic organization, a publication of a recognized research organization, or an internal analysis performed within the enterprise.

8. The method of claim 1, wherein generating the output comprising the one or more elements of information associated with the one or more peer entities that correspond with the one or more indicated features of the BI report context comprises:
generating a display output for display in a BI reporting user interface, the display output comprising a visual comparison of the one or more elements of information associated with the one or more peer entities with the corresponding one or more indicated features of the BI report context.

9. The method of claim 1, further comprising identifying the one or more information sources as they pertain to the one or more peer entities, prior to identifying the one or more elements of information associated with the one or more peer entities from the one or more information sources.

10. The method of claim 9, wherein identifying the one or more information sources as they pertain to the one or more peer entities comprises:
identifying one or more sources of information that are from a predefined set of authoritative sources or that have confirmable characteristics of authoritativeness, and that are indicated to comprise information pertaining to the one or more peer entities,
wherein identifying a source of information that has confirmable characteristics of authoritativeness comprises identifying a weighted minimum number of citations to the source among the sources of information in the predefined set of authoritative sources.

11. The method of claim 1, further comprising identifying the one or more peer entities of the enterprise prior to identifying the one or more elements of information associated with one or more peer entities of the enterprise.

12. The method of claim 11, wherein identifying the one or more peer entities of the enterprise comprises applying rules for identifying one or more entities with comparable categorical status to the enterprise and comparable metrics to the enterprise.
